(19) United States
(12) Patent Application Publication
(10) Pub. No.: US 2002/0037134 A1
(43) Pub. Date: Mar. 28, 2002

(54) Side pumping laser light source

(75) Inventors: Naoki Akamatsu, Kanagawa-ken (JP); Kiyoyuki Kawai, Kanagawa-ken (JP); Masanobu Kimura, Kanagawa-ken (JP); Kazuyoshi Fuse, Kanagawa-ken (JP); Tooru Sugiyama, Kanagawa-ken (JP); Ko Sato, Kanagawa-ken (JP)

Correspondence Address: PILLSBURY WINTHROP LLP, 1600 TYSONS BOULEVARD, MCLEAN, VA, 22102, US

(73) Assignee: KABUSHIKI KAISHA TOSHIBA, Tokyo (JP)

(21) Appl. No.: 09/961,340

(22) Filed: Sep. 25, 2001

(30) Foreign Application Priority Data
Sep. 28, 2000 (JP) P2000-296371

(51) Int. Cl. G02B 6/26; G02B 6/22; H01S 3/091; H01S 3/067

(52) U.S. Cl. 385/32; 385/127; 372/70; 372/6

(57) ABSTRACT

An optical fiber, having a fiber cladding and a fiber core doped with laser active material, is embedded in an optical waveguide core having a refractive index almost equal to that of the optical fiber cladding, and pumping light is guided, in a side pumping manner, from the semiconductor laser via the light-guiding section. The guided pumping light is absorbed by the laser active material, as it propagates and moves around in the optical waveguide core in a fixed direction. Because the optical waveguide core is ring-shaped and enclosed by the optical waveguide cladding having a low refractive index, the rest of the guided pumping light propagates and moves around in the optical waveguide core again. Therefore, a laser active material in the optical fiber core can be pumped efficiently.

### FIELD OF THE INVENTION

The present invention relates to a laser light source. The present invention, more particularly, relates to a side pumping fiber laser light source pumped by semiconductor laser light.

### BACKGROUND OF THE INVENTION

In H. Po, “High power neodymium-doped single transverse mode fibre laser”, Electronics Letters, Vol. 19, No. 17, August 1993, pp. 1500-1501, an example of a fiber laser using optical fiber with rare-earth ions doped as an active material and using a semiconductor laser (LD) as a pumping light source is disclosed.

The paper shows that laser light of 5 W in a wave-length band of 1.06 μm is obtained using an LD bar of multimode optical fiber bundle couple having a wavelength of 807 nm and output of 15 W as a pumping light source, and optical fiber with a core diameter of 7.5 μm having a fiber core region of a double-clad fiber structure doped with neodymium ions (Nd³⁺ ions), which are one of rare-earth ions.

However, when an LD is used as a pumping light source, a complicated lens system is required for incidence due to the poor-quality of light emission output of the LD. In this paper, although an optical fiber bundle-coupled LD bar is used, pumping light is entered from the end of the optical fiber using the lens system. Therefore, precise alignment is required and the source is expensive because the optical system is still complicated as a whole. Further, an extremely long optical fiber structure corresponding to the area ratio is required to allow rare-earth ions doped to the core to absorb pumping light because the area ratio between the core and the inner clad layer is high. Namely, in short optical fiber, pumping light is emitted unless it is absorbed by rare-earth ions doped to the core and the conversion efficiency is consequently reduced.

In an end face pumping type, into which pumping light is entered from the end face of the fiber, the pumping light reduces exponentially because a part of the light is absorbed in the active material of the core while it is propagating in the optical fiber. Therefore, a long fiber length is required and high cost is imposed to absorb the pumping light fully in the active material of the core. Additionally, the amount of heat, which is generated in correspondence to the absorption, is more near a side for inputting pumping light because the absorbed power of the pumping light is higher. Namely, the amount of heat is not uniform in the direction of the fiber length.

When the input of pumping light is to be increased using a plurality of LDs or a plurality of wavelengths are to be used for pumping, expensive additional parts, such as a coupling lens and a coupling prism, are required. Further, the laser fiber whose inner clad layer has no circular section is used in this paper. The manufacturing method for a fiber having no circular section is special and expensive.

### SUMMARY OF THE INVENTION

In accordance with an embodiment of the present invention, there is provided a side pumping laser light source capable of generating light having a predetermined wavelength from inputted pumping light and outputting the generated light. The side pumping laser light source comprises an optical fiber having a fiber core, in which a laser active material is pumped by the pumping light, and a fiber cladding, which encloses a periphery of the fiber core, the optical fiber through an end of which the generated light is outputted, a ring-shaped optical waveguide core having a refractive index almost equal to that of the fiber cladding, the optical waveguide core in which the optical fiber is partially or wholly embedded along the ring shape, an optical waveguide cladding having a refractive index lower than that of the optical waveguide core, the optical waveguide cladding which encloses a periphery of the optical waveguide core, and a light-guiding section having a refractive index almost equal to that of the optical waveguide core, the light-guiding section which connects with the optical waveguide core in the optical waveguide cladding to input the pumping light to the optical waveguide core in a predetermined direction.

Also in accordance with an embodiment of the present invention, there is provided a side pumping laser light source. The side pumping laser light source comprises a semiconductor laser configured to generate pumping light, a fiber core in which a laser active material is pumped by the pumping light and a light having a predetermined wavelength is generated, a fiber cladding enclosing a periphery of the fiber core, the fiber cladding and the fiber core constitute an optical fiber through an end of which the generated light is outputted, a ring-shaped optical waveguide core having a refractive index almost equal to that of the fiber cladding, the optical waveguide core in which the optical fiber is partially or wholly embedded along the ring shape, an optical waveguide cladding having a refractive index lower than that of the optical waveguide core, the optical waveguide cladding which encloses a periphery of the optical waveguide core, and a light-guiding section having a refractive index almost equal to that of the optical waveguide core, the light-guiding section which connects with the optical waveguide core in the optical waveguide cladding to input the pumping light to the optical waveguide core in a predetermined direction.

### BRIEF DESCRIPTION OF THE DRAWINGS

The accompanying drawings, which are incorporated in and constitute part of this specification, illustrate various embodiments and/or features of the invention and together with the description, serve to explain the principles of the invention.

In the drawings:

FIGS. 1(a) and 1(b) are respectively a plan view and a perspective view of an optical waveguide of the laser light source consistent with a first embodiment of the present invention;

FIGS. 2(a) and 2(b) are respectively a cross sectional view of the optical waveguide shown in FIGS. 1(a) and 1(b) and a drawing showing refractive index distribution;

FIGS. 3(a) and 3(b) are drawings showing examples of the optical fibers off-centered in the optical waveguide shown in FIGS. 1(a) and 1(b);

FIG. 4 is a plan view of an optical waveguide of the laser light source consistent with a second embodiment of the present invention;

FIG. 5 is a perspective view of an optical waveguide core of the laser light source consistent with a third embodiment of the present invention;

FIG. 6 is a plan view of an optical waveguide of the laser light source consistent with a fourth embodiment of the present invention;

FIG. 7 is a plan view of an optical waveguide of the laser light source consistent with a fifth embodiment of the present invention;

FIG. 8 is a plan view of an optical waveguide of the laser light source consistent with a sixth embodiment of the present invention;

FIG. 9 is a plan view of an optical waveguide of the laser light source consistent with a seventh embodiment of the present invention; and

FIG. 10 is a plan view of an optical waveguide of the laser light source consistent with an eighth embodiment of the present invention.

### DETAILED DESCRIPTION

First Embodiment

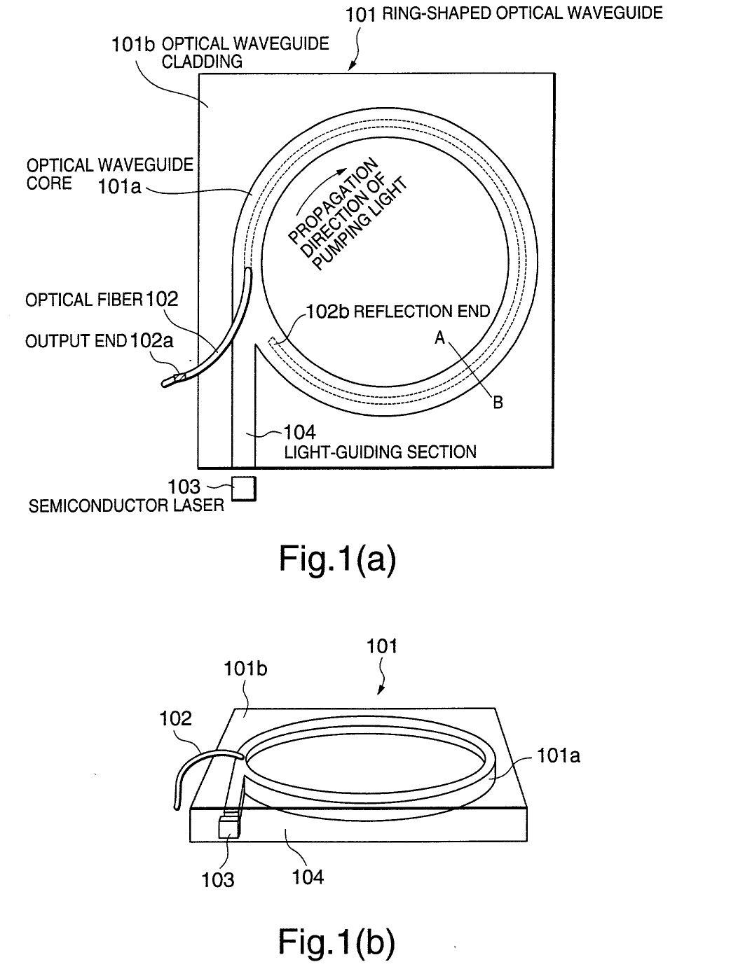

FIGS. 1(a) and 1(b) are respectively a plan view and a perspective view of an optical waveguide of the laser light source consistent with a first embodiment of the present invention.

An optical waveguide 101 has an optical waveguide core 101a and an optical waveguide cladding 101b whose refractive index is lower than that of the core 101a. The optical waveguide core 101a is ring-shaped. The outer periphery of the optical waveguide core 101a is covered with the optical waveguide cladding 101b and formed as a waveguide for shutting in and propagating pumping light (described later). The optical waveguide core 101a and the optical waveguide cladding 101b are made of resin transparent at the wavelength of the pumping light, for example, polymethyl methacrylate (PMMA), polycarbonate (PC), silicone, styrene-acrylonitrile (SAN), or glass.

In the optical waveguide core 101a, an optical fiber 102 of a single clad is embedded along the ring shape. In this case, the optical fiber 102 with a length of about one round may be reserved in the optical waveguide core 101a, so that the cost of optical fiber can be reduced. In a core of the optical fiber 102, rare-earth ions, which are a laser active material, are doped. These rare-earth ions may be praseodymium ions (Pr³⁺), thulium ions (Tm³⁺), holmium ions (Ho³⁺), erbium ions (Er³⁺), ytterbium ions (Yb³⁺), and neodymium ions (Nd³⁺). Ytterbium ions (Yb³⁺) may be cited as co-doped sensitizer ions for the excitation of main doped ions using energy transfer mechanisms.

In this embodiment, an example of a fluoride glass optical fiber 102 doped with praseodymium ions (Pr³⁺) and ytterbium ions (Yb³⁺) will be explained. It is said that fluoride glass, such as indium fluoride glass, aluminum fluoride glass, or zirconium fluoride glass, has a small amount of phonon energy and it is desirable as a glass matrix material of a doped optical fiber. The rare earth ions in the optical fiber 102 are pumped by light with a wavelength of 850 nm and used to constitute a so-called upconversion fiber laser for outputting 635-nm laser light.

One end 102a of the optical fiber 102 is pulled out from the optical waveguide core 101a and used as a 635-nm laser output end. The other end 102b of the optical fiber 102 is embedded in the optical waveguide core 101a.

A semiconductor laser 103 is a semiconductor laser for emitting light with a pumping wavelength 850 nm and has a wide light emission area (e.g., 500 μm (width)×1 μm (thickness)) due to high output. Light emitted from the semiconductor laser 103 enters a light-guiding section 104 of the optical waveguide 101.

The section of the light-guiding section 104 is a waveguide of a high numerical aperture (NA) having a core and a clad having a high refractive index difference. And the area of the core of the light-guiding section 104 to be face the semiconductor laser 103 is slightly bigger than the light emission area of the semiconductor laser 103. So, it produces an effect that light can enter without precise alignment.

The incident light is guided to the ring of the optical waveguide 101 from the light-guiding section 104. The core of the light-guiding section 104 intersects the ring shape of the optical waveguide core 101a at such a small angle that it is almost tangential to the ring shape so as to effectively join. The core of the light-guiding section 104 is made of a material the same as that of the optical waveguide core 101a and integrated with it. The clad of the light-guiding section 104 is made of a material the same as that of the optical waveguide cladding 101b and integrated with it.

Therefore, the optical waveguide 101 functions as a waveguide with a Y junction. Namely, pumping light guided from the light-guiding section 104 effectively joins the ring of the optical waveguide 101, being partially absorbed by the laser active material in the core of the fiber 102. Then the pumping light propagates and moves around clockwise in FIG. 1(a). The rest of the pumping light moves around and reaches the junction again. Thus the pumping light, which was not absorbed by the laser active material, is propagated along the ring continuously, so that it is effectively used for pumping. Because the pumping light is propagated in a direction along the ring, there is also an effect produced that there is little returning light from the optical waveguide to the semiconductor laser. With respect to the returning light, it is more desirable to apply an anti-reflection coating for air onto the incident aperture of the light-guiding section 104 and suppress reflection of the laser light at the incident aperture of the light-guiding section 104.

Further, the output end 102a of the optical fiber is pulled out in the opposite direction of the moving direction (clockwise) of the pumping light. The reason is that as compared with a case of pullout in the same direction, there is an effect produced that the pumping light scatters little at the position where the optical fiber 102 is pulled out across the optical waveguide 101.

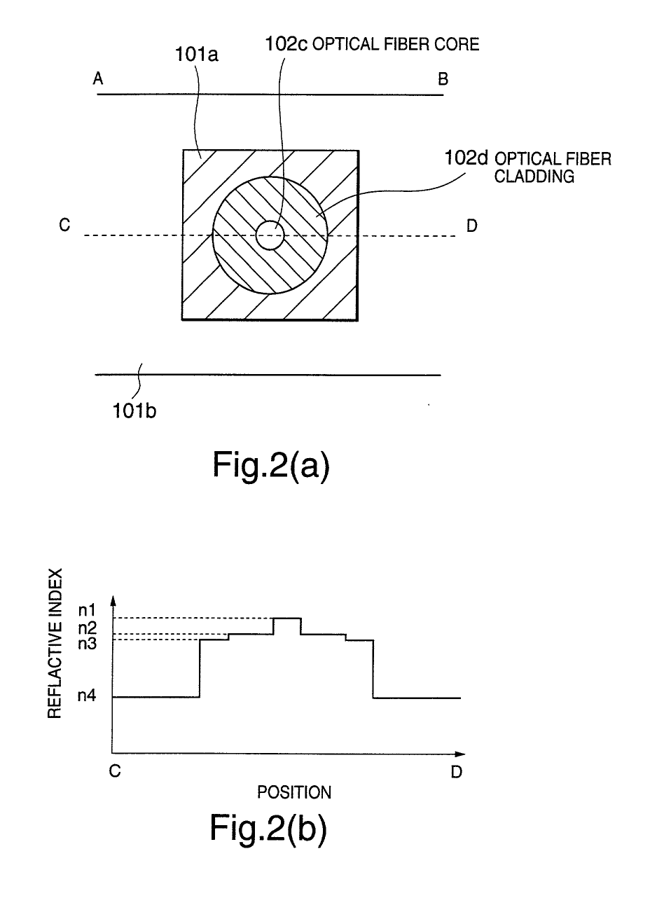

FIG. 2(a) is a cross sectional view of the optical waveguide taken along line A-B shown in FIGS. 1(a). The optical fiber 102 having an optical fiber core 102c and an optical fiber cladding 102d is embedded in the optical waveguide core 101a. Further, the optical waveguide core 101a is enclosed by the optical waveguide FIG. 2(b) is a drawing showing refractive index distribution along line C-D shown in FIGS. 2(a).

The optical fiber core 102c, the optical fiber cladding 101d, the optical waveguide core 101a, and the optical waveguide cladding 101b have a refractive index n1, n2, n3, and n4, respectively. N2 and n3 are almost equal to each other, n1 is the highest, n4 is the lowest, and the difference between n3 and n4 is relatively large. Therefore, the pumping light is propagated in the multi mode using the optical fiber core 102c, the optical fiber cladding 102d, and the optical waveguide core 101a collectively as a core, and the optical waveguide cladding 101b as a clad so that almost all the energy can be shut in the collective core. The pumping light propagating in the optical waveguide like this is absorbed by Yb³⁺ ions or Pr³⁺ ions of the optical fiber core 102c during propagation.

Further, since the sectional shape of the optical waveguide core 102a is made polygonal instead of circular, the mode mixture effect of the pumping light propagation modes is obtained.

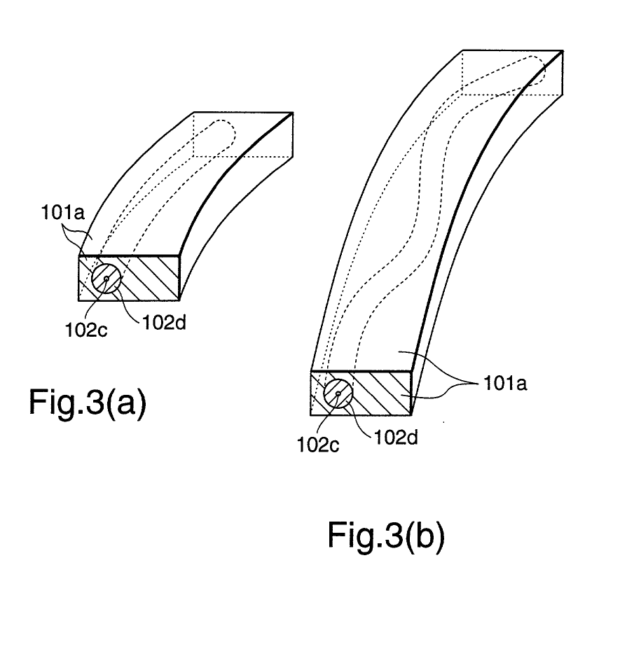

FIGS. 3(a) and 3(b) are drawings showing examples of the optical fibers off-centered in the optical waveguide shown in FIGS. 1(a) and 1(b). The optical fiber 102 is made off-centered in the optical waveform core 101a; thereby the efficiency of pumping light incidence absorption into the optical fiber core 102c can be improved. As shown in FIG. 3(a), a fixed off-centered position may be used. As shown in FIG. 3(b), the off-centered position may be changed and arranged.

The end face of the optical fiber can be a reflective surface as it is. However, in this embodiment, the reflectivity at the output end 102a of the optical fiber is set to several tens percent within a narrow band in the neighborhood of 635 nm, which is a desired oscillation wavelength, by a fiber Bragg grating which is an attached reflector. Further, the reflectivity at the reflective end 102b of the optical fiber is set to almost 100 percent in a wide band around the neighborhood of 635 nm by a dielectric multilayer film, which is another reflector. By doing this, the interval between both reflectors has a laser cavity structure. Therefore, one of the laserable wavelengths is decided and oscillated by the reflection characteristics of the fiber Bragg grating having sharp wavelength selectivity and output from the output end 102a of the optical fiber 102.

The fiber Bragg grating is placed on the side of the output end 102a to be pulled out instead of the reflective end 102b contained in the optical waveguide 101. As a result, the fiber Bragg grating is away from heating elements such as the fiber doped with rare-earth ions, a heat sink (not shown) for the doped fiber or the semiconductor laser, so that it can make the temperature of the grating change a little and make the fluctuation of the reflective characteristic of the fiber Bragg grating small.

By doing this, the rest of the pumping light moved around the ring again propagates along the optical waveguide core and be absorbed by rare-earth ions. Thus, the optical fiber is enough to be small in length in comparison with the length required in end face pumping type laser light sources. For example, an optical fiber with a length of about one round may be reserved at least in the optical waveguide core, so that the cost can be reduced. From the viewpoint of the constitution, precise alignment is not required and pumping light can be entered comparatively easily. Further, since pumping light propagates and moves around the ring shape, the pumping light can be used usefully and little returning light runs backward the light-guiding section. Further, when a plurality of light-guiding sections are installed and pumping light with the same wavelength is to be guided, the propagation direction of pumping light is preset to be fixed, so that the returning light propagating backward the light-guiding section can be reduced. In addition, when a plurality of light-guiding sections are installed according to desired output, input of pumping light is increased as much as necessary, thereby a scalable laser light source can be obtained.

The case of upconversion is explained above. However, the same may be said with a case that a laser fiber for oscillating the laser by converting the wavelength to a one longer than the wavelength of pumping light is used.

Second Embodiment

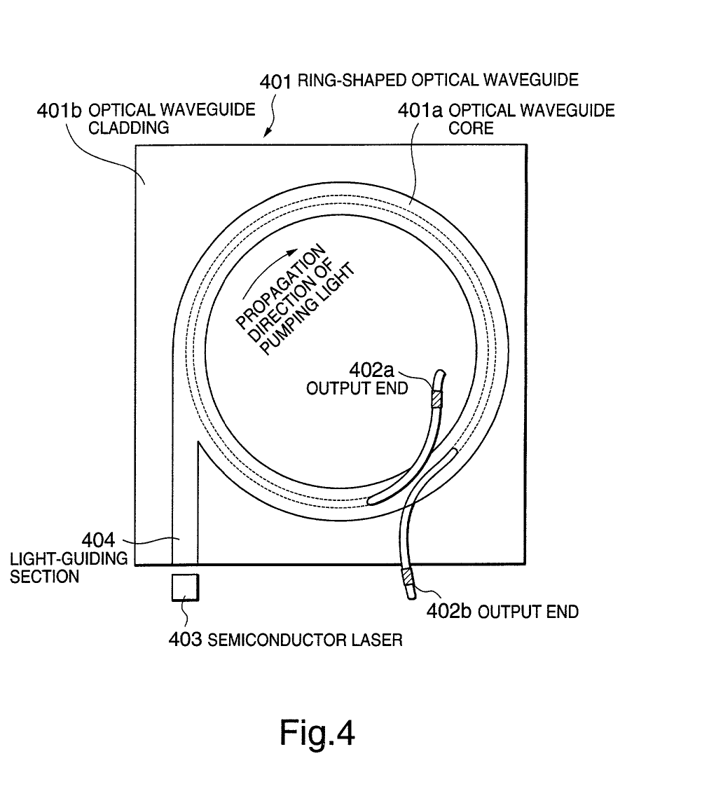

FIG. 4 is a plan view of an optical waveguide of the laser light source consistent with a second embodiment of the present invention. As shown in FIG. 4, both fiber ends 402a and 402b may be pulled out from the optical waveguide 101.

The optical fiber 402 is a single clad and has a general coaxial shape that the core is not off-centered and positioned at the center, so that it can be manufactured at a low price without using a special manufacturing method and there is an advantage that a conventional art such as an optical connector can be used to connect the output end 402a of the optical fiber to another optical fiber.

Third Embodiment

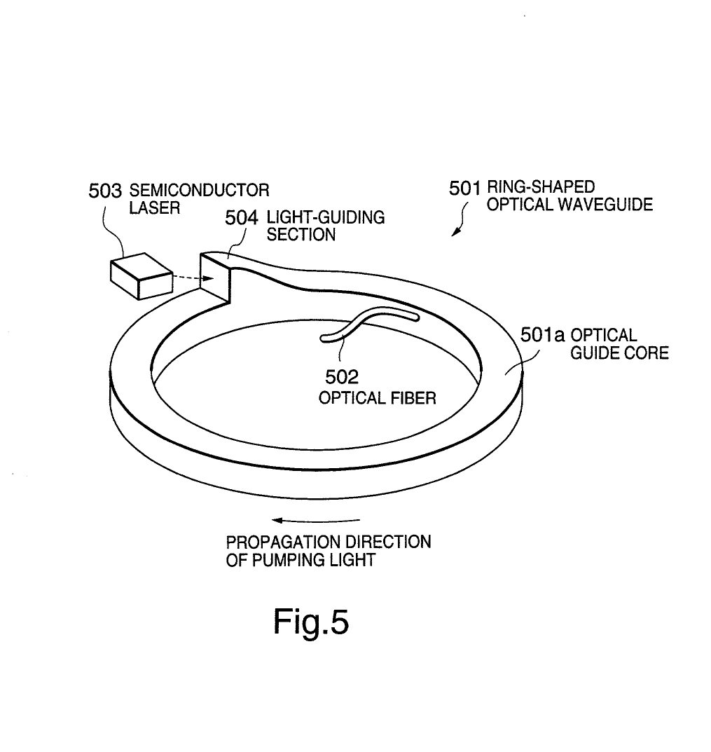

FIG. 5 is a perspective view of an optical waveguide core of the laser light source consistent with a third embodiment of the present invention. As an optical waveguide 501 shown in FIG. 5, pumping light may be guided from a light-guiding section 504 installed at a position, which is not the ring surface of the optical waveguide 501 to an optical waveguide core 501a. In FIG. 5, for simplicity, the optical waveguide clad and the optical fiber in the waveguide core are omitted and only the optical waveguide core 501a is shown.

Fourth Embodiment

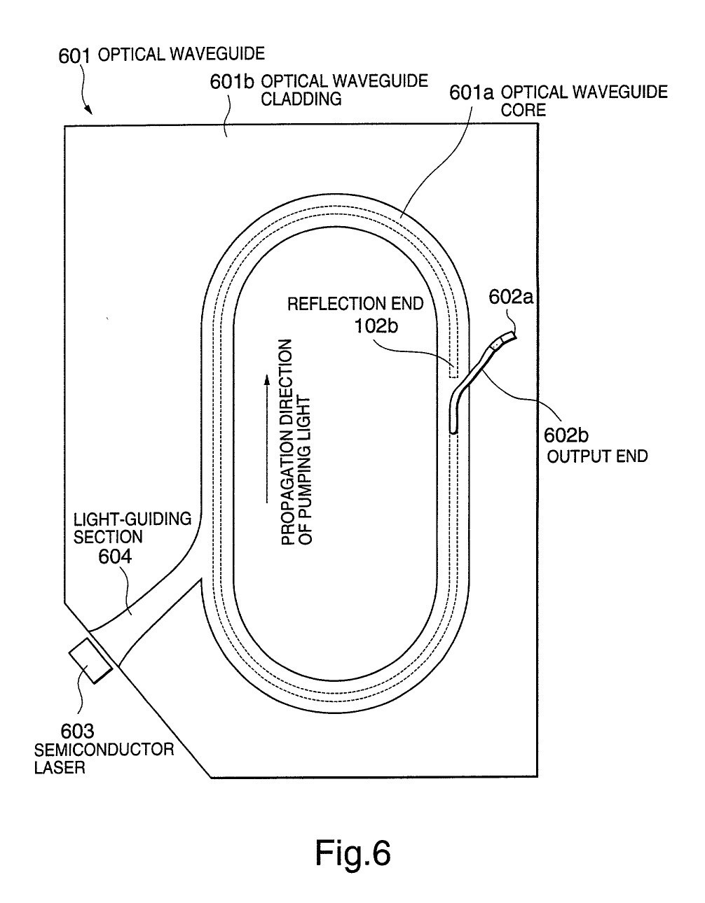

FIG. 6 is a plan view of an optical waveguide of the laser light source consistent with a fourth embodiment of the present invention. As an optical waveguide 601 shown in FIG. 6, a linear part may be installed on a part of an optical waveguide core 601a. In FIG. 6, a light-guiding section 604 is shaped so as to branch on the linear part of the waveguide core 601a. Moreover, the pullout position of the output end 602a of the optical fiber 602 and the position of the reflective end 602b are also on the linear part of the optical waveguide core 601a.

Generally, existence of junction, pullout of the optical fiber, and the reflective end etc. causes disturbance of propagation of pumping light. Further, in a bent waveguide, radiation is easily generated in the outward direction opposite to the bending direction. Therefore, the joint part of the light-guiding section 604 and the optical waveguide core 601a, which causes disturbance of propagation of pumping light, and both ends of the optical fiber are arranged on the linear part instead of the curved line part of the waveguide core 601a, thereby the loss of radiation is controlled small.

Fifth Embodiment

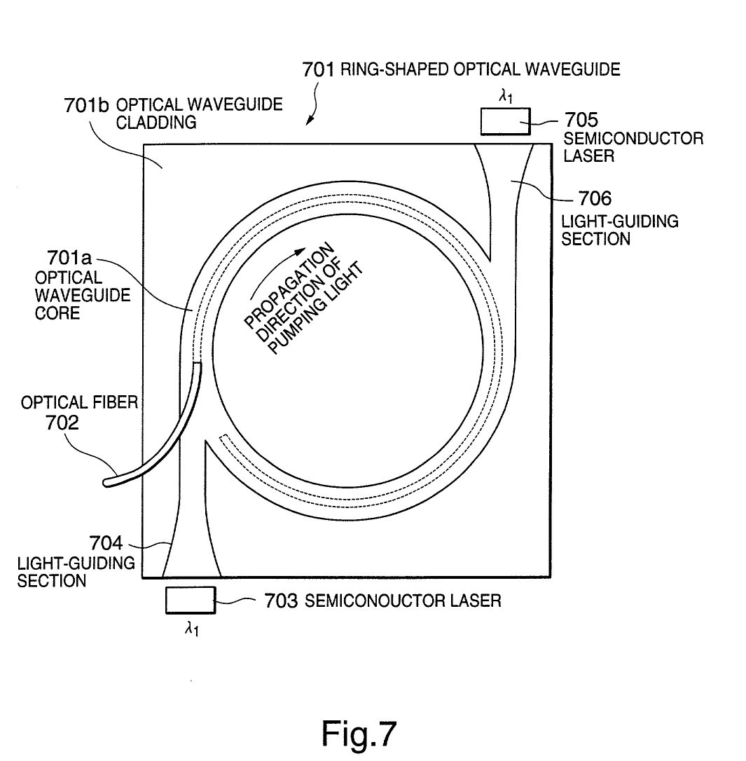

FIG. 7 is a plan view of an optical waveguide of the laser light source consistent with a fifth embodiment of the present invention. In FIG. 7, a laser light source (not shown) has a structure for pumping using a plurality of semiconductor lasers having the same oscillation wavelength. An optical waveguide 701 has a ring-shaped optical waveguide core 701a and an optical waveguide cladding 701b enclosing the periphery thereof. An optical fiber 702 of a single-clad structure that rare-earth ions are doped into the core region as a laser active material is contained in the optical waveguide core 701a.

Laser light in a pumping wavelength band λ1 output from a first semiconductor laser 703 is propagated to a first light-guiding section 704, prepares its intensity distribution, and then joins the ring part of the optical waveguide 701. On the other hand, laser light in a pumping wavelength band λ1 output from a second semiconductor laser 705 is propagated to a second light-guiding section 706, prepares its intensity distribution, and then joins the ring part of the optical waveguide 701.

The first light-guiding section 704 and the second light-guiding section 706 preset so as to make the propagation direction of pumping light propagating each of the light-guiding sections match with the same direction (clockwise in FIG. 7) on the ring part of the optical waveguide 701. The arrangement of a plurality of light-guiding sections produces an effect that returning light from the optical waveguide to the semiconductor laser is small.

As the optical waveguide core receives pumping lights at two portions, the intensity of the pumping light and the heat generated in accompanying with the absorption of the pumping light become more uniform in the direction of the fiber length.

Sixth Embodiment

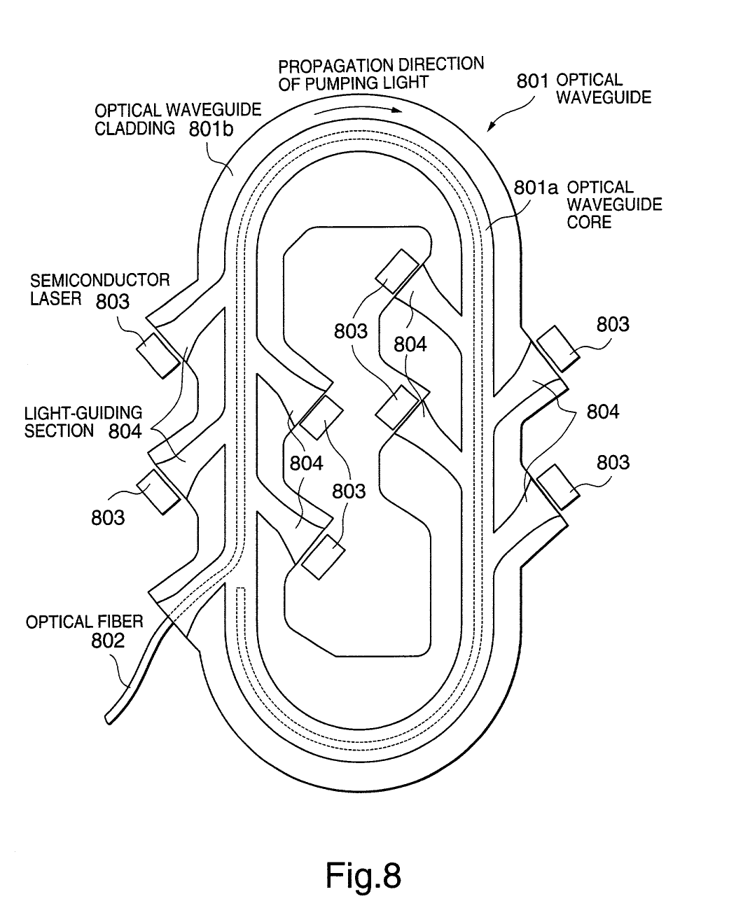

FIG. 8 is a plan view of an optical waveguide of the laser light source consistent with a sixth embodiment of the present invention. In FIG. 8, a laser light source for pumping using many semiconductor lasers as a pumping light source is shown. An optical waveguide 801 has a ring-shaped optical waveguide core 801a and an optical waveguide cladding 801 and an optical fiber 802 that rare-earth ions are doped into the core region is contained in the optical waveguide core 801a. Laser light in a pumping wavelength band λ1 generated from a plurality of semiconductor lasers 803 is propagated to light-guiding sections 804 corresponding to the respective semiconductor lasers 803 and joins the ring part of the optical waveguide 801.

Since the light-guiding sections 804 are arranged so that the propagation direction of the pumping light propagated from each of the light-guiding sections 804 is set to the same direction (clockwise in FIG. 8) on the ring part of the optical waveguide 801, there is an effect produced that returning light from the optical waveguide to the semiconductor laser is small. Further, a linear part is installed on the optical waveguide core 801a in the same way as with FIG. 6 and the branch joint part of each of the light-guiding sections 804 is arranged on the linear part, so that there is an effect produced that the radiation loss is reduced.

As mentioned above, a plurality of light-guiding sections are installed depending on desired output and by use of a plurality of semiconductor lasers, pumping light input can be increased by as much as necessary. In this case, the optical waveguide may be changed and new parts are not required.

Seventh Embodiment

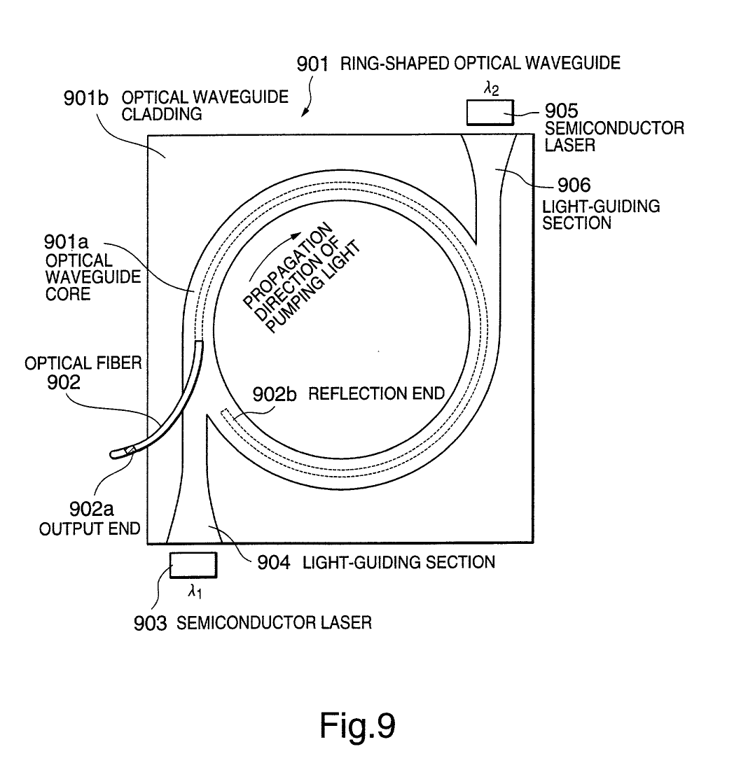

FIG. 9 is a plan view of an optical waveguide of the laser light source consistent with a seventh embodiment of the present invention. An optical waveguide 901 has a ring-shaped optical waveguide core 901a and an optical waveguide cladding 901b. An optical fiber 902, whose core is doped with rare-earth ions as a laser active material, is contained in the optical waveguide core 901a. Laser light in a pumping wavelength λ1 generated from a semiconductor laser 903 enters a light-guiding section 904, propagates, and joins to the ring part of the optical waveguide 901. On the other hand, laser light in a pumping wavelength λ2 generated from a semiconductor laser 905 enters a light-guiding section 906, propagates, and joins to the ring part of the optical waveguide 901.

At an output end 902a of the optical fiber, a fiber Bragg grating, which is a reflector having a reflectivity of several tens percent at an oscillation wavelength λ3, is installed. On the other hand, at a reflective end 902b of the optical fiber, a dielectric multilayer film, which is a reflector having a reflectivity of almost 100 percent at an oscillation wavelength λ3, is attached. Therefore, a laser cavity structure is formed between both reflectors and a 2-wavelength pumping laser light source for outputting the wavelength λ3 using light at the wavelength λ1 and light at the wavelength λ2 as pumping light is obtained. For example, a case that an optical fiber with Pr³⁺ or Yb³⁺ doped is used, and the wavelength λ1 is pumped as a band of 980 nm, and the wavelength λ2 is pumped as a band of 810 nm, and 635-nm laser output is obtained may be cited.

Although the case employing two pump sources of different wavelengths is explained in this embodiment, using more than two wavelengths is possible by properly preparing light-guiding sections and semiconductor lasers for outputting necessary pumping wavelengths. Further, although the case where each wavelength is set up by one semiconductor is explained in this embodiment, each wavelength may be set up by a plurality of semiconductor lasers using a light-guiding section additionally installed.

Eighth Embodiment

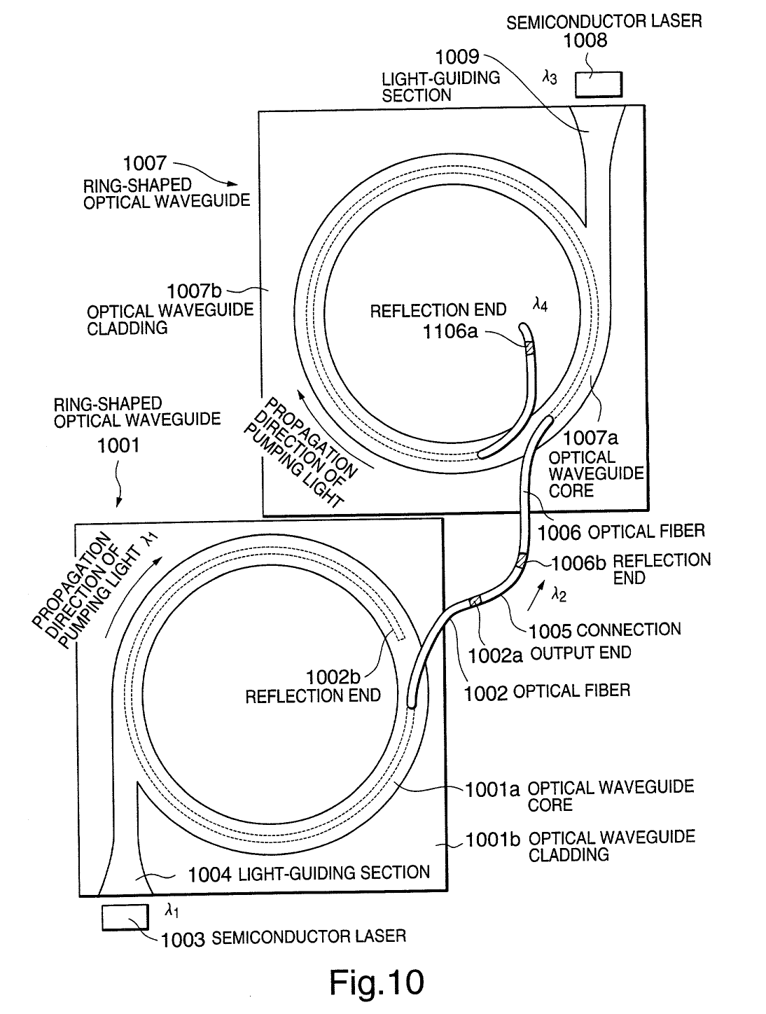

FIG. 10 is a plan view of an optical waveguide of the laser light source consistent with an eighth embodiment of the present invention. The laser light source is a 2-wavelength pumping laser light source, and one pumping wavelength light enters from the end face of the optical fiber, and the other pumping wavelength light enters from the side using the optical waveguide. It may be said that the laser light source relating to this embodiment is connected in stages as a pumping light source.

A first optical waveguide 1001 has a ring-shaped optical waveguide core 1001a and an optical waveguide cladding 1001b. An optical fiber 1002, whose core is doped with rare-earth ions as a laser active material, is contained in the optical waveguide core 1001a. Laser light in a pumping wavelength λ1 generated from a semiconductor laser 1003 enters a light-guiding section 1004, propagates, and joins to the ring part of the optical waveguide 1001.

At an output end 1002a of the optical fiber 1002, a fiber Bragg grating having a reflectivity of several tens percent in a narrow band of a fiber laser oscillation wavelength band λ2 is installed. On the other hand, at a reflective end 1002b contained in the optical waveguide core 1001a, a dielectric multilayer film having a reflectivity of almost 100 percent in a wide band including the fiber laser oscillation wavelength λ2 is attached. Therefore, a laser cavity structure is formed between the reflectors and laser light at the wavelength λ2 is oscillated. The laser light at the wavelength λ2 is propagated to an optical fiber 1006 from the output end 1002a via a connection 1005.

The optical fiber 1006, whose core is doped with rare-earth ions as a laser active material, is contained in a ring-shaped optical waveguide core 1007a of a second optical waveguide 1007. The optical waveguide 1007 is connected to the optical waveguide core 1007a with an optical waveguide cladding 1007b enclosing it. On the other hand, laser light with the oscillation wavelength λ3 generated by a semiconductor laser 1008 is propagated to a light-guiding section 1009 and joins the ring part of the optical waveguide 1007.

At an output end 1006a of the optical fiber 1006, a fiber Bragg grating having a reflectivity of several tens percent at the fiber laser oscillation wavelength λ4 is installed. At another reflective end 1006b, a fiber Bragg grating having a reflectivity of almost 100 percent at the fiber laser oscillation wavelength λ4 is installed. Therefore, a laser cavity structure is formed between the reflectors and the rare-earth ions are pumped by the two pumping wavelengths λ2 and λ3 light, so the embodiment produces a laser light at the wavelength λ4. It is possible to set the fiber Bragg grating positioned at the reflective end 1006b to a reflectivity of almost 100 percent even at the pumping wavelength λ3 for efficiency of pumping light.

By doing as explained above, laser light with a desired wavelength λ4 is obtained from the output end 1006a by the laser light source. For example, there is a constitution available that an optical fiber doped with both Pr³⁺ and Yb³⁺ is used as an optical fiber 1002, the pumping wavelength λ1 is obtained by the 850-nm semiconductor laser 1003, and the oscillation wavelength λ2 obtains 635-nm laser light, while an optical fiber doped with Tm³⁺ is used as an optical fiber 1007, the pumping wavelength λ 3 is obtained by the 1210-nm semiconductor laser 1008, and the oscillation wavelength λ4 obtains 480-nm laser light.

In each of the embodiments mentioned above, several examples of the shape of optical waveguide are explained. However, the characteristic of the present invention is that pumping light guided from the light-guiding section is efficiently joined in the optical waveguide and propagated and moved around in the fixed direction, so that any other closed shape for moving pumping light around may be applied.

What is claimed is:

1. A side pumping laser light source capable of generating light having a predetermined wavelength from inputted pumping light and outputting the generated light, comprising:
an optical fiber having a fiber core, in which a laser active material is pumped by the pumping light, and a fiber cladding, which encloses a periphery of the fiber core, the optical fiber through an end of which the generated light is outputted;
a ring-shaped optical waveguide core having a refractive index almost equal to that of the fiber cladding, the optical waveguide core in which the optical fiber is partially or wholly embedded along the ring shape;
an optical waveguide cladding having a refractive index lower than that of the optical waveguide core, the optical waveguide cladding which encloses a periphery of the optical waveguide core; and
at least one light-guiding section having a refractive index almost equal to that of the optical waveguide core, the light-guiding section which connects with the optical waveguide core in the optical waveguide cladding to input the pumping light to the optical waveguide core in a predetermined direction.

2. The laser light source of claim 1, wherein the light-guiding section connects with the optical waveguide core in parallel with a tangential direction of the ring shape.

3. The laser light source of claim 1, wherein a cross section of the optical waveguide core is polygonal.

4. The laser light source of claim 1, wherein the optical fiber is off-centered on a cross section of the optical waveguide core.

5. The laser light source of claim 1, wherein the optical waveguide core has a pair of linear parts in the ring shape, one of the linear parts where the light-guiding section connects with the optical waveguide core.

6. The laser light source of claim 1, wherein the optical waveguide core has a part of linear parts in the ring shape, one of the linear parts where the outputting end is pulled out from the optical waveguide core.

7. The laser light source of claim 1, wherein:
the outputting end is pulled out from the optical waveguide core in the opposite direction of the predetermined direction; and
the other end of the optical fiber is embedded in the optical waveguide core.

8. The laser light source of claim 7, wherein:
the outputting end has a reflector configured to reflect light having the predetermined wavelength; and
the other end has a reflector configured to reflect light having a wavelength within a wavelength band including the predetermined wavelength.

9. The laser light source of claim 1, further comprising:
a second light-guiding section having a refractive index almost equal to that of the optical waveguide core, the second light-guiding section which connects with the optical waveguide core in the optical waveguide cladding to input a second pumping light to the optical waveguide core in the predetermined direction, the second pumping light which has the same wavelength as that of the first pumping light inputted through the first light-guiding section.

10. The laser light source of claim 1, further comprising:
at least one second light-guiding section having a refractive index almost equal to that of the optical waveguide core, the second light-guiding section which connects with the optical waveguide core in the optical waveguide cladding to input second pumping light to the optical waveguide core in the predetermined direction, the second pumping light which has a wavelength different from that of the first pumping light inputted through the first light-guiding section.

11. The laser light source of claim 10, wherein the optical guide core has a pair of linear parts in the ring shape, the linear parts where the first and second light-guiding sections connect with the optical waveguide core.

12. A side pumping laser light source, comprising:
a semiconductor laser configured to generate pumping light;
a fiber core in which a laser active material is pumped by the pumping light and a light having a predetermined wavelength is generated;
a fiber cladding enclosing a periphery of the fiber core, the fiber cladding and the fiber core constitute an optical fiber through an end of which the generated light is outputted;
a ring-shaped optical waveguide core having a refractive index almost equal to that of the fiber cladding, the optical waveguide core in which the optical fiber is partially or wholly embedded along the ring shape;
an optical waveguide cladding having a refractive index lower than that of the optical waveguide core, the optical waveguide cladding which encloses a periphery of the optical waveguide core; and
at least one light-guiding section having a refractive index almost equal to that of the optical waveguide core, the light-guiding section which connects with the optical waveguide core in the optical waveguide cladding to input the pumping light to the optical waveguide core in a predetermined direction.

13. The laser light source of claim 12, wherein:
the light-guiding section connects with the optical waveguide core in parallel with a tangential direction of the ring shape; and
the semiconductor laser inputs the pumping light to the light-guiding section in parallel with the tangential direction.

14. The laser light source of claim 12, further comprising:
a second light-guiding section having a refractive index almost equal to that of the optical waveguide core, the second light-guiding section which connects with the optical waveguide core in the optical waveguide cladding to input second pumping light to the optical waveguide core in the predetermined direction, the second pumping light which has the same wavelength as that of the first pumping light inputted through the first light-guiding section; and
a second semiconductor laser configured to input the second pumping light to the second light-guiding section.

15. The laser light source of claim 12, further comprising:
at least one second light-guiding section having a refractive index almost equal to that of the optical waveguide core, the second light-guiding section which connects with the optical waveguide core in the optical waveguide cladding to input second pumping light to the optical waveguide core in the predetermined direction, the second pumping light which has a wavelength different from that of the first pumping light inputted through the first light-guiding section; and
a second semiconductor laser configured to input the second pumping light to the second light-guiding section.
